(19) United States
(12) Patent Application Publication
(10) Pub. No.: US 2001/0032808 A1
(43) Pub. Date: Oct. 25, 2001

(54) Device for intercepting, filtering and balancing the water supplied in water treatment plants

(76) Inventor: Giordano Otelli, Brescia (IT)

Correspondence Address: MCGLEW & TUTTLE, PC, SCARBOROUGH STATION, SCARBOROUGH, NY, 10510, US

(21) Appl. No.: 09/811,205

(22) Filed: Mar. 17, 2001

(30) Foreign Application Priority Data
Mar. 17, 2000 (IT) BS2000A000024

(51) Int. Cl. B01D 33/82

(52) U.S. Cl. 210/97; 210/223; 210/449; 137/801

(57) ABSTRACT

A device for intercepting and filtering cold and hot water for water treatment plants includes a body passed through by a first cold water transit sluice and by a second hot water transit sluice. In these sluices there are inserted a usually open stop valve (17), a filtering filter (19), a magnetic anti-limestone conditioner (22) and a pressure balancer (21) at least along the hot water sluice (14).

### FIELD OF THE INVENTION

The present invention pertains, in general, to water treatment plants, and in particular, to a device for intercepting and filtering both cold and hot water in said plants.

### BACKGROUND OF THE INVENTION

On the one hand, a device is known from a previous patent application of the same applicant for intercepting and filtering hot and cold water in water treatment plants, comprising a body passed through by two sluices for the transit of cold water and hot water, respectively, and in each of which are inserted a usually open stop valve and a filter for filtering the water.

On the other hand, a pressure balancer has become known that is suitable for compensating the pressure variations of the water coming from the distribution network and for avoiding any flow fluctuations, maintaining constant the ratio of the output of the two types of water regardless of the pressure.

A magnetic anti-limestone conditioner is also known which, arranged along a water duct, acts by an ionic accelerator, preventing the aggregation, therefore the deposit, of calcareous substances transported by the water.

### SUMMARY AND OBJECTS OF THE INVENTION

The intercepting and filtering device mentioned above has become capable of implementation of such functions. One object of the present invention is to provide a device for water treatment plants which comprises, besides the intercepting and filtering functions, the balancing of the pressure of the water supplied.

Another object of the present invention is to provide a device for water treatment plants that comprises, besides the intercepting and filtering functions, an anti-limestone treatment of the water.

Another object of the present invention is to provide a device for water treatment plants that comprises, at the same time, besides the intercepting and filtering functions, a balancing of the pressure of the water supplied and an anti-limestone treatment of the water.

The above-mentioned objects are accomplished with a multifunction device that comprises, along the water sluices, an intercepting valve, a filter, a pressure balancer and/or a magnetic anti-limestone conditioner.

According to the invention, a device for intercepting and filtering cold and hot water for water treatment plants is provided, which comprises a body passed through by a first cold water transit sluice and by a second hot water transit sluice. In each of these there is inserted a usually open stop valve and a filtering filter. A pressure balancer is incorporated at least along the hot water sluice.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a front sectional view of the device; and

FIG. 2 is a top view of a section of the device.

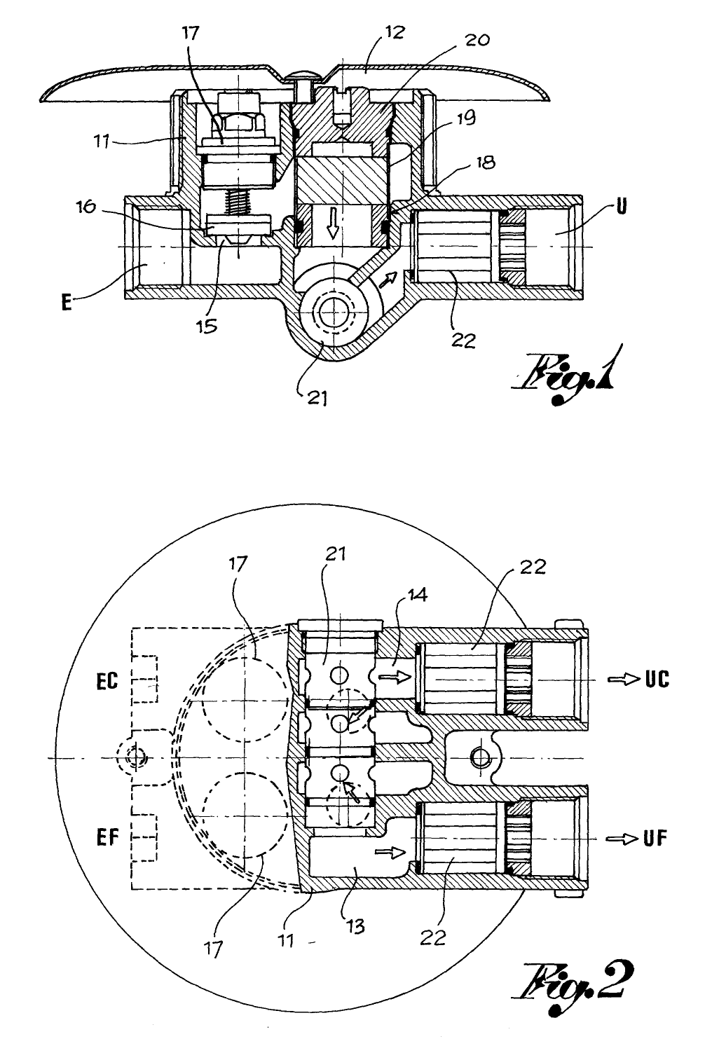

### DESCRIPTION OF THE PREFERRED EMBODIMENT

Referring to the drawings in particular, the device in question comprises a container body 11 to be embedded in a wall and closed in the front by a flange 12. In the body there are provided a first sluice 13 with an inlet EF and an outlet UF to which is connected a cold water pipe and a second sluice 14 with an inlet EC and an outlet UC to which is connected a hot water pipe.

Along each of the sluices 13 and 14 are provided a valve seat 15, to which is coordinated a shutter 16 of a stop valve 17; a housing 18 in which is inserted a filter 19 with a related filter carrier 20; and a seat for a possible magnetic anti-limestone conditioner 22.

A pressure balancer 21 may be inserted along at least the hot water sluice 14.

The intercepting valve 17 in each sluice 13, 14 is usually open, and thus makes possible the passage of the water from the respective inlet to the filtering block 19, by means of the seat 15.

The filter 19 may consist of an aerator having suitable features or any other filtering element that is able to hold back the solid particles transported by the water.

At least the hot water passes through, if present, the pressure balancer 21, which, as stated previously, compensates for the pressure variations, avoiding flow fluctuations and thus maintaining constant the ratio of the output of the two types of hot and cold water.

Where provided the water is also treated by the magnetic anti-limestone conditioner 22 which is applied coaxially to the water sluice.

By placing the stop valve 17 in the closed position, it is possible to carry out maintenance on the apparatus below the device and, if necessary, to easily access the filters 19, the pressure balancer 21 and the anti-limestone conditioners 22 for the cleaning and/or replacement thereof.

While specific embodiments of the invention have been shown and described in detail to illustrate the application of the principles of the invention, it will be understood that the invention may be embodied otherwise without departing from such principles.

What is claimed is:

1. A device for intercepting and filtering cold and hot water for water treatment plants, the device comprising:
a body passed through by a first cold water transit sluice and by a second hot water transit sluice;
a said usually open stop valve inserted in each of said first cold water transit sluice and said second hot water transit sluice;
a filter for filtering; and
a pressure balancer disposed along said hot water sluice.

2. A device for intercepting and filtering cold and hot water for water treatment plants, the device comprising:
a body forming a first cold water transit sluice and by a second hot water transit sluice;
a usually open stop valve inserted into said first cold water transit sluice and said second hot water transit sluice;
a filter; and
a magnetic anti-limestone conditioner disposed along each of said cold and hot water sluices.

3. A device for intercepting and filtering cold and hot water for water treatment plants, the device comprising:
a body forming a first cold water transit sluice and by a second hot water transit sluice;
a usually open stop valve inserted into said first cold water transit sluice and said second hot water transit sluice;
a filter;
a pressure balancer disposed along said hot water sluice;
a magnetic anti-limestone conditioner along said cold water sluice; and
a magnetic anti-limestone conditioner along said hot water sluice.
